(19) United States
(12) Patent Application Publication
(10) Pub. No.: US 2002/0099587 A1
(43) Pub. Date: Jul. 25, 2002

(54) Method of support of environmentally concerned design of manufactured goods, and method and system for providing recycling support information

(75) Inventors: Yu Kakihana, Funabashi (JP); Yoshiaki Ichikawa, Naka-gun (JP); Hiroyuki Matsuo, Tokyo (JP); Tomotoshi Ishida, Hitachinaka (JP); Yuzo Hiroshige, Tokyo (JP); Yasushi Sugimoto, Tokorozawa (JP)

Correspondence Address: Crowell & Moring LLP, The Evenson, Mckeown, Edwards & Lenahan, Intellectual Property Law Gr., 1001 Pennsylvania Avenue, N.W., Washington, DC, 20004-2595, US

(73) Assignee: HITACHI, LTD.

(21) Appl. No.: 09/995,723

(22) Filed: Nov. 29, 2001

(30) Foreign Application Priority Data
Jan. 19, 2001 (JP) 2001-10963

(51) Int. Cl. G06F 17/60

(52) U.S. Cl. 705/7

(57) ABSTRACT

In a method of support of environmentally concerned design of manufactured goods, making it such that a manufacturer can easily entrust environmental evaluation of manufactured goods to an external environmental evaluator, and the burden pertaining to environmental evaluation of manufactured goods of a manufacturer can be alleviated.

A confidentiality agreement is concluded between an environmental evaluator and manufacturer, the manufacturer provides component list files based on components structures, and materials and chemical substances related to assembly products to the environmental evaluator, the environmental evaluator performs a process of environmental evaluation of said products by computer based on environmentally concerned design database 21d and sends the evaluation results to said manufacturer, and the manufacturer performs environmentally concerned design of the products by considering the evaluation results.

### BACKGROUND OF THE INVENTION

1. Field of the Invention

The present invention pertains to a method of environmental evaluation of manufactured goods as well as a method and system for providing recycled product information, and in particular, it relates to that which is well suited as a method of environmental evaluation in which an environmental evaluator that has an environmental evaluation database performs evaluation of assembly products of a plurality of manufacturers, as well as a system and method of providing recycling support information in which data related to assembly products possessed by manufacturers is provided to recycling operators.

2. Description of Related Art

As a method of environmental effect evaluation of the past, as shown in Japanese Unexamined Patent Gazette H10-21216, general evaluation with prioritization for management among areas of environmental load is performed, and also in order to provide a method of environmental effect evaluation in which prioritization for management of environmental aspects of organizations for each area of environmental load is efficiently performed, there is one that evaluates by combining an environmental load importance evaluation table in which quantitative ordering of necessity of management among environmental loads, concerning environmental loads represented such as by air pollution, water pollution, soil pollution, noise and vibration, depletion of resources, and industrial waste pollution, is performed, and an environmental aspect evaluation table in which quantitative ordering of necessity of management of environmental aspects represented by environmental management elements such as chemical storage facilities, production equipment, raw materials, fuel, energy, industrial waste for each of said environmental loads is performed.

Also, as a device for evaluation of environmental load of products of the past, as shown in Japanese Unexamined Patent Gazette H10-57936, in order to provide a device with which the environmental load in the life cycle of a product is grasped simply, there is one that comprises: an input means in which product-specific information such as each constituent component, material, and quantity of a product is input; a processing means in which the life cycle of a product is modeled by the environmental load in the stage in which that product is manufactured and used and the environmental load in the stage of discarding and recycling of that product, product-specific information such as each constituent component, material, and quantity of the product is individually input corresponding to that product, also information such as said constituent components, materials and input energy is acquired based on statistical data prepared in advance, and computation is performed based on said model; and an output means for outputting processing results of the processing means.

Also, as an environmental management support system of the past, as shown in Japanese Unexamined Patent Gazette H10-124587, in an environmental management support system that comprises: a plurality of distributed environmental management target sites; an environmental management office server that is placed in an office that is in charge of environmental management of all of said environmental management target sites; an environmental information server that sends necessary information for environmental management from outside to said environmental management target sites via a communication circuit; and a departmental terminal that inputs data related to environmental aspects from each department in said environmental management target sites, there is one in which menus for selecting environmental aspects are displayed on the screen of said departmental terminal based on selection menu data provided by said environmental management office server; data of environmental aspects input from said departmental terminal for each item of environmental aspects predetermined by the menus is totalized, whereby the environmental aspects of all sites are managed; and selection menu data provided by said environmental management office server is regularly sent from said environmental information server. By this environmental management support system, when environmental aspects are entered by each department, totalization becomes possible because the names are unified; mismatches of materials balances among departments comes to be detected easily, and in addition, each site can uniformly track even when items of environmental aspects change with the times.

Also, as a system for management of environmental load of products of the past, as shown in Japanese Unexamined Patent Gazette H11-161709, there is one in which data of life cycles of products is managed for each production process by making environmental loads correspond with identification numbers, only a necessary minimum of data is disclosed by using a transmission path for other processes that use those products, and information of environmental loads in life cycles of products is commonly managed in all production processes, whereby information of environmental loads for life cycle assessment of products is automatically accumulated, and it is superior in accumulation of data necessary for reduction of environmental loads of products and in confidentiality of businesses.

Also, as a device for product life cycle planning support of the past, as shown in Japanese Unexamined Patent Gazette H11-288427, in order to provide a support device for new products development which can reduce environmental loads in the overall product life cycle, there is one that comprises: an environmental quality functional deployment database that holds design guidelines and information related to environmental problems; a product design know-how database that has accumulated information of various design examples obtained in past products development; a first support means that acquires the most appropriate environmentally harmonious design guidelines in a target product based on degree of importance assigned to environmental problems in each stage of the product life cycle process and problems to be considered at the end of the product life from said environmental quality functional deployment database and presents them; and a second support means that retrieves design know-how for realizing design guidelines presented by this first support means from said product design know-how database and presents it.

Also, as an environmental information management system of the past, as shown in Japanese Unexamined Patent Gazette H11-290832, in order to make it possible that a user can select a product that is less harmful to the environment by generating and distributing environmental information in the production process or life cycle of a product, there is one in which an environmental information management device, and the like, of each corporation is connected by a wide area network; the management device comprises a network communication section for transmitting and receiving with other management devices, an environmental information database, an environmental information compiling section, an acquisition device for reading environmental information attached to products, and an output device for printing environmental information attached to one's own products; the environmental information consists of data items such as manufacturer, model (product name), constituent substances and their quantities, amount of energy consumption (converted to kcal) required for manufacturing, hazardous substances and their quantities, and the like; and when corporation D assembles product d from components a, b, and c, environmental information from corporations A, B, and C and environmental information generated in one's own operations are totalized for each item, and are stored in a database as environmental information of product d, and in addition, a part of the environmental information and an access address are printed so as to be attached to product d.

Also, as a product evaluation device of the past, as shown in Japanese Unexamined Patent Gazette 2000-37684, there is one that comprises: a database in which attributes of materials are recorded; an input section in which shapes of components that constitute products are designed and materials that are used in the above components are specified; a memory section in which attributes of the above products associating attributes of materials recorded in the above database and materials of the above components specified by the above input section, and shapes of the above components designed by the above input section are recorded; a computing section in which the characteristics of the above products are computed based on the shapes of the above components and the attributes of the above components recorded in the above memory section; and an output section in which computational results computed by the above computing section are output, whereby it is made possible to perform design while evaluating the recycling capability ratio and environmental loads of the overall product by quantitative evaluation in the course of design of a product.

Also, as a life cycle management system of the past, as shown in Japanese Unexamined Patent Gazette 2000-48066, there is one in which the entire life cycle of a flow until discarding or recycling after manufacturing a product is managed for every product; in order to provide a life cycle management method which can rationalize the judgment and processing procedures when recycling or discarding said product or its components, system, and product, a storing means such as an IC tag is attached to each product; various information (product type, with or without built-in recycled components, types of components and attributes of each component, discard methods for each component, sales routes, repair and maintenance histories, and the like) for life cycle management is stored in said storing means at each site (for example, manufacturer, sales company, service company, collection company, processing company, and the like); also further detailed information is stored in databases at each site, and said databases can be accessed with the ID of a product from anywhere.

Also, as a recycling system for electrical and electronic appliances of the past, as shown in Japanese Unexamined Patent Gazette 11-300330, in a recycling system for used electrical and electronic appliances, in order to plan for improvement of recycling rate through reuse as products and reuse as components by utilizing environmental information data, and plan for making recycling system multidimensional by properly and smoothly processing target products of multiple appliance types and feeding back conditions in decomposition processes and regeneration processes to product design, there is one that has a means for outputting a processing procedure by determining whether or not reuse is possible as a product based on an environmental information database, a means for outputting instructional results for components decomposed in the decomposition process by determining whether or not reuse is possible as a component to post-processing, a means for writing working time and evaluation scores in the decomposition process in the environmental information database, and a means for writing examination results information.

Also, in a recycling system of the past, as shown in Japanese Unexamined Patent Gazette 2000-181958, in order to provide a recycling system in which recycled products using recycled components, and the like, can be produced as planned, there is one that comprises: a recycling information memory database in which information on all reusable products, components and raw materials including products, components and raw materials produced or used under management of said system, which also are products, components and raw materials subject to discarding disposal, and products, components and raw materials presently being used on the market, is stored as recycling information; a virtual recycled product design section in which times and quantities in which reusable products, components and raw materials are collected as products, components and raw materials that can be used in recycling are predicted based on recycling information stored in the recycling information memory database; and a production planning section in which a production plan for recycled products using reusable products, components and raw materials is established based on predicted times and quantities.

### SUMMARY OF THE INVENTION

However, in the prior art described above, it is not indicated that a manufacturer can easily entrust environmental evaluation based on component structures of assembly products and their materials and chemical substances to an external environmental evaluator, and there was a problem that it was difficult to perform fully environmentally concerned design for assembly products.

Also, in the prior art described above, it is not indicated that product recycling information, that is, a component list file created from data on components structure and their materials and chemical substances related to assembly products possessed by a manufacturer is provided to a recycling operator, and there was a problem that it was difficult to perform product recycling having sufficiently considered the environment.

The purpose of the present invention is to provide a method of support of environmentally concerned design of manufactured goods in which a manufacturer can easily entrust environmental evaluation of manufactured goods to an external environmental evaluator, and the burden pertaining to environmental evaluation of manufactured goods of a manufacturer can be alleviated.

Another purpose of the present invention is to provide a system for providing product recycling support information and method of providing the same in which a recycling operator can easily perform product recycling having fully considered the environment.

Another purpose of the present invention is to provide a method of support of environmental operation in which environmental evaluation can be entrusted by sending environmental data of each department of a manufacturer to an external environmental evaluator, and tasks having considered the environment of products can be performed across all departments of a manufacturer.

In a representative example of the method of support of environmentally concerned design according to the present invention for achieving the above-mentioned purposes, it is constituted such that: a confidentiality agreement is mutually concluded between an environmental evaluator that possesses an environmentally concerned design database and a plurality of assembly manufacturers; the above manufacturers submit component list files constituted based on components structure related to their assembly products and materials and chemical substances thereof to the above environmental evaluator via a communication circuit; the above environmental evaluator performs a process of environmental evaluation of said products by computer based on the above environmentally concerned design database, and sends the evaluation results to the manufacturers of said assembly products via the communication circuit; and the above manufacturers perform environmentally concerned design of the above assembly products by considering the above evaluation results.

In a representative example of the system for providing recycling support information according to the present invention for achieving the above-mentioned purposes, it is constituted comprising: a means for creating a component list file from component structures data and materials and chemical substances data related to assembly products possessed by manufacturers; a means for converting this component list file into web compliant data; and a means for sending the above web compliant data to a recycling operator via a communication circuit.

In a representative example of the method of providing recycling support information according to the present invention for achieving the above-mentioned purposes, it is constituted such that: a component list file is created from component structures data and materials and chemical substances data based on design data related to assembly products possessed by a manufacturer; the above component list file is provided to a provider that possesses a product recycling information providing system; the above provider converts the above component list file into web compliant data; and the above provider provides the above web compliant data to a recycling operator.

In a representative example of the method of support of environmental operation according to the present invention for achieving the above-mentioned purposes, it is constituted such that: a confidentiality agreement is concluded between an environmental evaluator that possesses an environmental evaluation database and evaluation know-how and a plurality of manufacturers; environmental data of design departments, manufacturing departments, and environmental management departments related to assembly products of each manufacturer is sent to the above environmental evaluator via a communication circuit; the above environmental evaluator performs a process of environmental evaluation of said products by computer based on the above database; and the above evaluation results are sent to the above manufacturers via a communication circuit.

### BRIEF DESCRIPTION OF THE DRAWINGS

FIG. 1 is an explanatory drawing of an environmental operation information system having applied each system of the present invention.

FIG. 2 is a hardware configuration drawing of the environmental operation information center server used in the environmental operation information system in FIG. 1.

FIG. 3 is an explanatory drawing showing one preferred embodiment of the method of support of environmentally concerned design of the present invention.

FIG. 4 is a drawing for explaining an example of outputting from the CAD database and the environmentally concerned design database in FIG. 3.

FIG. 5 is a drawing showing an example of a screen output from the environmentally concerned design database in FIG. 3.

FIG. 6 is a drawing showing another example of a screen output from the environmentally concerned design database in FIG. 3.

FIG. 7 is a drawing showing another example of a screen output from the environmentally concerned design database in FIG. 3.

FIG. 8 is an explanatory drawing showing one preferred embodiment of the system for providing recycling support information of the present invention.

FIG. 9 is an explanatory drawing showing another preferred embodiment of the system for providing recycling support information of the present invention.

### DESCRIPTION OF THE PREFERRED EMBODIMENTS

Below, a preferred embodiment of the present invention is explained, referring to the drawings.

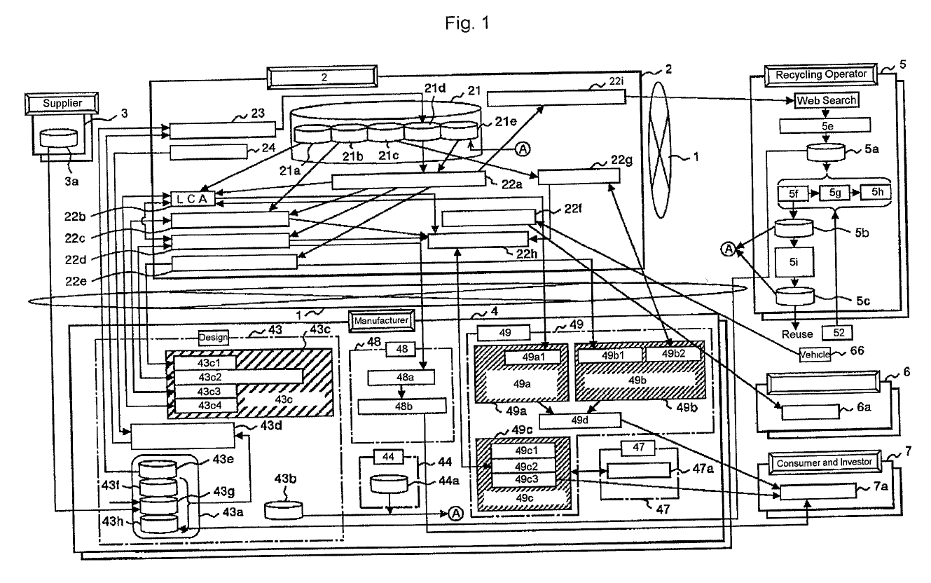

First, the structure and operation of an environmental operation information system having applied each system of the present invention is explained using FIG. 1. FIG. 1 is an explanatory drawing of an environmental operation information system having applied each system of the present invention. In FIG. 1, the arrow passing through Internet 1 indicates the flow of information sent back and forth via communication circuit 1, and in the following explanation, explanation of the point about being performed via Internet 1 is omitted.

This environmental operation information system, as shown in FIG. 1, is constituted by environmental operation information center server 2 which is managed by an environmental operation information center, supplier terminals 3 which are managed by a plurality of suppliers that supply components and materials, and the like, manufacturer system 4 that has a plurality of departmental terminals 43, 44, 47-49 which are managed by a plurality of manufacturers, recycling operator terminals 5 which are managed by a plurality of recycling operators, transport operator terminals 6 which are managed by a plurality of collection and transport operators which perform collection and transport of manufactured goods, and consumer and investor terminals 7 which are managed by a plurality of general consumers and investors, being connected via Internet 1 which constitutes the communication circuit. Accordingly, these servers, terminals and the system perform sending and receiving of information via communication circuit 1. The communication circuit also may be a communication circuit such as radio communication instead of this Internet 1.

In this environmental operation information system, the environmental operation information center is an outsider (for example, a separate organization like a different corporation, and the like) with respect to the suppliers, manufacturers, recycling operators, collection and transport operators, and consumers and investors. Then, the suppliers, manufacturers, recycling operators, collection and transport operators, and consumers and investors that participate in this environmental operation information system mutually conclude confidentiality agreements with the environmental operation information center. Through this, passwords are given out by the environmental operation information center to those who have concluded confidentiality agreements, and connection of supplier terminals 3, manufacturer systems 4, recycling operator terminals 5, collection and transport operators 6, and consumers and investors 7 with environmental operation information center server 2 becomes possible by inputting this password. The environmental operation information center becomes also a provider being a supporter, in addition to becoming an environmental evaluator.

Environmental operation information center server 2 has comprehensive environmental information database 21 which is a database that has comprehensively collected environmental information. This comprehensive environmental information database 21 constitutes an environmental evaluation database, and it is divided into separate databases being environmental effect evaluation database 21a, decomposability/recyclability evaluation database 21b, chemical substance management database 21c, environmentally concerned design database 21d and history database 21e.

Regarding these environmental effect evaluation database 21a, decomposability/recyclability evaluation database 21b, and chemical substance management database 21c, standard databases are held by the environmental operation information center, or the databases are constituted by obtaining applied databases from those participating in the environmental operation information system. And, environmental effect evaluation database 21a is used as input data of LCA system 22b, decomposability/recyclability evaluation database 21b is used as input data of decomposability/recyclability evaluation system 22c, and chemical substance management database 21c is used as input data of chemical substance discharge system 22g.

Regarding environmentally concerned design database 21d, the database is constituted by that information sent from design department terminals 32 is automatically converted by automatic conversion system 23 and is stored. This sent information includes component list files, recycling process order data, and the like. And, regarding environmentally concerned design database 21d, component names, materials, weights, and the like, are output to LCA system 22b and decomposability/recyclability evaluation system 22c, green product information, and the like, are output to green procurement support system 22d, and content chemical substance information, and the like, are output to product content chemical substance management system 22e via environmentally oriented task support system 22a.

Also, regarding history database 21e, the database is constituted by data being input from product and component life database 32b of design department terminal 43, assembly records database 44a of manufacturing department terminal 44, and decomposing records database 5b and inspection/repair records database 5c of recycling operator terminal 5. Regarding environmentally concerned design database 21d and history database 21c, recycled products information and history information of each product and component, and the like, are output to recycling support product information providing system 22i via environmentally oriented task support system 22a.

Also, environmental operation information center server 2 comprises environmentally oriented task support system 22a, LCA system 22b (LCA: Life Cycle Assessment), decomposability/recyclability evaluation system 22c, green procurement support system 22d, product content chemical substance management system 22e, collection and transport support system 22f, chemical substance discharge system 22g, material quantity effect computation support system 22h and recycling support product information providing system 22i for performing various evaluation, management, support, and information provision, and the like, based on comprehensive environmental information database 21.

Environmentally oriented task support system 22a performs output for support of input operations of LCA system 22b and decomposability/recyclability evaluation system 22c, and in addition, outputs green product information to green procurement support system 22d, and outputs content chemical substance information, and the like, to product content chemical substance management system 22e. LCA system 22b outputs quantitative values of environmental loads, and the like, to material quantity effect computation support system 22h.

Decomposability/recyclability evaluation system 22c outputs decomposition time, recycling rate, and the like, to material quantity evaluation computation system 22h. Green procurement support system 22d outputs quantity of environmental effect, and the like, to LCA system 22b, and in addition, inputs quantity of green purchasing, and the like, to material quantity effect computation support system 22h. Product content chemical substance management system 22e outputs content chemical substance information, and the like, to comprehensive chemical substance management system 49b.

Collection and transport support system 22f detects positions of vehicles 6b via a satellite communication circuit, and in addition, outputs positioning information, and the like, to transport operation management system 6a of collection and transport operator terminal 6. Material quantity effect computation system 22h inputs usage quantities of hazardous chemical substances, and the like, from chemical substance discharge system 22g, and in addition, outputs values of effects of material quantities to environmental accounting system 49c. Chemical substance discharge system 22g, inputs and outputs purchased chemical substances, totalized results of each discharge (discharges to soil, water, air, and the like), legal data, chemical substance information, and the like, with comprehensive chemical substance management system 49b, and in addition, outputs usage quantities of hazardous chemical substances, and the like, to <material quantity> effect computation support system 22h.

Recycling support product information providing system 22i inputs recycled product information and history information of products and components, and the like, from environmentally oriented task support system 22a, and in addition, outputs to recycling operator terminal 5.

Regarding these control systems, the operations are performed with each system being systematically linked, moreover, the operations are performed constituting the main parts of separate systems in linkage with external supplier terminals 3, manufacturer systems 4, recycling operator terminals 5, collection and transport operator terminals 6, and consumer and investor terminals 7. By this, effective environmental operation becomes possible.

Furthermore, environmental operation information center server 2 comprises automatic conversion system 23 which automatically converts information sent from manufacturers based on the confidentiality agreement with the manufacturers, and custom sheet providing system 24 which provides custom sheets to the manufacturers.

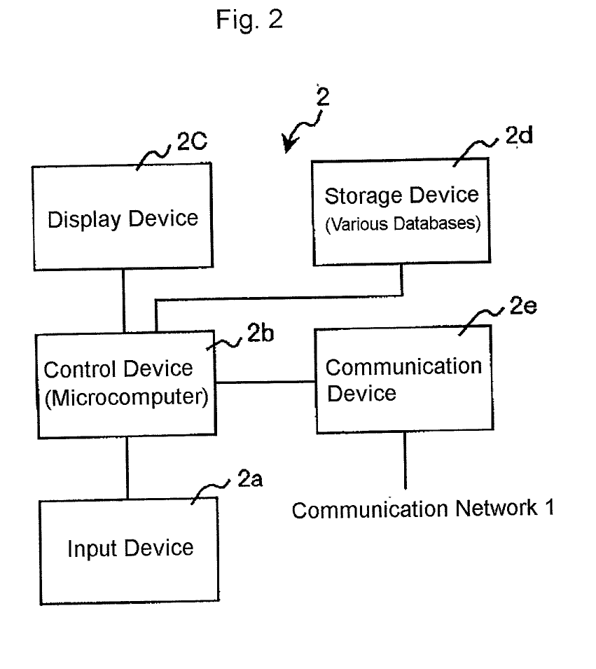

Here, the hardware configuration of environmental operation information center server 2 is explained using FIG. 2. FIG. 2 is a hardware configuration drawing of the environmental operation information center server used in the environmental operation information system in FIG. 1.

This environmental operation information center server 2 has input device 2a, control device 2b, display device 2c, storage device 2d, and communication device 2e. Input device 2a has a character input section consisting of a keyboard, and the like, an image input section consisting of an image reading device or electronic image input device, and the like, and an acoustical input device such as a microphone, and the like, and it is connected to control device 2b. Control device 2b is constituted with a microcomputer, and the like, and it performs the main processing of environmentally oriented task support system 22a, LCA system 22b, decomposability/recyclability evaluation system 22c, green procurement support system 22d, product content chemical substance management system 22e, collection and transport support system 22f, chemical substance discharge system 22g, material quantity effect computation support system 22h, recycling support product information providing system 22i, automatic conversion system 23 and custom sheet providing system 24. Display device 2c is constituted with a CRT display or liquid crystal display device, and the like, it is connected to control device 2b, and it displays input contents and received contents, and the like. Storage device 2d stores comprehensive environmental information database 21, and it is connected to control device 2b. Communication device 2e has the functions of making environmental operation information center server 2 capable of sending and receiving with Internet 1, and it is connected between Internet 1 and control device 2b.

Because the hardware configuration of each terminal such as supplier terminal 3, each department terminal of the manufacturers, recycling operator terminal 5, collection operator terminal 6, and consumer and investor terminal 7 is fundamentally the same as that of environmental operation information center server 2, explanation thereof is omitted.

Returning to FIG. 1, manufacturer system 4 is constituted with design department terminal 43 which is managed by the design department, manufacturing department terminal 44 which is managed by the manufacturing department, accountants department terminal 47 which is managed by the accountants department, business department terminal which is managed by the business department and environmental management department terminal 49 which is managed by the environmental management department being connected via the manufacturer internal Intranet (not illustrated). The manufacturer internal Intranet is connected to Internet 1. Accordingly, design department terminal 43, manufacturing department terminal 44, accountants department terminal 47, business department terminal 48 and environmental management department terminal 49 which constitute manufacturer system 4 are connected to environmental operation information center server 2 and other terminals 3, 5-7 via the manufacturer internal Intranet and Internet 1.

And, design department terminal 43 has design department database 43a, and product and component life database 43b which constitute the environmental design database, and in addition, it has environmentally concerned design system 43c and design information creation system 43d. This design department database 43a furthermore is divided into separate databases such as CAD database 43e, components structure database 43f, materials and chemical substances database 43g and recycling process database 43h.

In this CAD database 43e, CAD data created by the design department is registered, and it is provided to environmentally concerned design database 21d via automatic conversion system 23 of environmental operation information center server 2. In components structure database 43f, components structure data created by the design department is registered. Materials and chemical substances database 43g is made so as to create a database by acquiring components information including green information sent from supplier terminal 3, and by this, the database can be made filled up by acquiring detailed components information possessed by suppliers, and in addition, the database can be created easily. Also, materials and chemical substances database 43g is made so as to register by adding components information created by the design department, and by this, the database can be made even more filled up. Also, recycling process database 43h acquires recycling process data from recycling process database 5a of recycling operator terminal 5. And, components structure database 43f, materials and chemical substances database 43g, and recycling process database 43h are used as input data of design information creation system 43d.

Also, in product and component life database 43b, product (component) life data created by the design department is registered, and it is used as input data of history database 21e of environmental operation information center server 2.

Environmentally concerned design system 43c is a system for performing environmentally concerned design, and it uses green procurement support system 22d and product content chemical substance management system 22e by web searching via environmentally oriented task support system 22a of environmental operation information center server 2, and in addition, it sends back after inputting data to be evaluated to input sheets sent from LCA system 22b, decomposability/recyclability evaluation system 22c and green procurement support system 22d, and is made so as to evaluate evaluation results received after that.

This environmentally concerned design system 43c is a system for performing creation of component list files and creation of process order data using data of components structure database 43f, materials and chemical substances database 43g and recycling process database 43h, and it provides the created component list files and process order data to automatic conversion system 23 of environmental operation information center server 2.

And, manufacturing department terminal 44 has assembly records database 44a. In this assembly records database 44a, assembly records data created by the manufacturing department is registered, and that data is provided to history database 21e of environmental operation information center server 2.

Business department terminal 48 can search material compositions of green materials constituting assembly products, totalization results, and places where green materials are used in component tables and drawings by web searching green procurement support system 22d of environmental operation information center server 2. By this, each business department can output green products information based on these search results, and provide them to consumers and investors, and perform business activities for their own products having considered the environment. It also may be made such that they are provided to evaluation and investment systems 7a of consumers and investor terminals 7 via Internet 1, and in this case, they can be provided rapidly to consumers and investors. By this, consumers and investors can confirm more accurately the circumstances of dealing with the environment by that manufacturer, and can use these as reference for purchasing of products and investment in stocks, and the like.

Accountants department terminal 47 has general accounting system 47a. This general accounting system 47a is made so as to operate in linkage with environmental accounting system 49c of environmental management department terminal 49.

Environmental management department terminal 49 has environmental effect analysis and evaluation system 49a, comprehensive chemical substance management system 49b and environmental accounting system 49c. This environmental effect analysis and evaluation system 49a sends back after inputting data to be evaluated to input sheets sent from LCA system 22b of environmental operation information center server 2, evaluates evaluation results received after that, outputs as data for publication of information such as environmental reports, and provides them to consumers and investors.

Also, comprehensive chemical substance management system 49b web searches product content chemical substance management system 22e of environmental operation information center server 2. Also, it sends back after inputting data to input sheets sent from chemical substance discharge system 22g, performs evaluation from totalization results, law data, and information related to handling of chemical substances received after that, outputs as data for publication of information such as environmental reports, and provides them to consumers and investors.

Also, environmental accounting system 49c is linked with general accounting system 47a of accountants department terminal 47; it totalizes costs for environmental conservation and in addition calculates effects of environmental conservation, outputs these results as data for publication of information such as environmental reports, and provides them to consumers and investors. For computation of effects of environmental conservation, and particularly effects of material quantities, quantitative values of environmental loads, decomposition time, recycling rate, and the like, quantity of green purchases, quantities of use of hazardous chemical substances are sent from LCA system 22b, decomposability/recyclability evaluation system 22c, green procurement support system 22d and chemical substance discharge system 22g to the material quantity effect computation support system, and in material quantity effect computation support system 22h, the effects of the material quantities are computed, and they are sent to environmental accounting system 49c. These results are used for effects of environmental conservation, and particularly for effects of material quantities, in environmental accounting.

Environmental accounting is a system for quantitatively grasping and publishing the costs (investment amounts and expenses of a term) for environmental conservation in corporate activities and effects thereof. Environmental accounting system 49c described above is one for performing quantitative grasp of the costs accompanying environmental conservation activities and their effects, and provision of necessary information for rational decisionmaking, or for planning for further efficiency of sustainable environmental conservation activities performed by manufacturers.

A supplier supplies components and materials to manufacturers, and it possesses supplier terminal 3. Supplier terminal 3 has components information database 3a in which information pertaining to components and materials including green information is registered. Components information database 3a is used as input data of materials and chemical substances database 43g.

A recycling operator performs recycling of assembly products manufactured by manufacturers, and it possesses recycling operator terminal 5. Recycling in the present preferred embodiment includes reuse of assembly products, reuse and reprocessed reuse of their components, waste disposal of assembly products and their components, and the like. Recycling operator terminal 5 has recycling process database 5a, decomposition records database 5b and inspection/repair records database 5c.

And, the recycling operator web searches recycling support product information providing system 22i by recycling operator terminal 5 and drafts a recycling process plan, and then registers that recycling process plan in recycling process database 5a. The recycling operator decomposes, treats, and disposes of assembly products based on this recycling process plan. Regarding decomposed components, their decomposition records are inspected after being registered in decomposition records database 5b, and they are repaired when necessary and reused. Inspection/repair records are registered in inspection/repair records database 5c. Decomposition records database 5b and inspection/repair records database 5c are used as input data of history database 21e.

A collection and transport operator collects assembly products manufactured by manufacturers from consumers and transports them to recycling operators, and it possesses collection and transport operator terminal 6. This collection and transport operator terminal 6 has transport operation management system 6a for devising efficient transport with a plurality of vehicles 6b which collect and transport assembly products. This transport operation management system 6a performs transport operation management by acquiring positioning information of vehicles 6b from collection and transport support system 22f of environmental operation information center server 2.

A consumer or investor examines purchasing of products or investment in manufacturers based on information related to the environment, and the like, published by manufacturers, and it possesses consumer and investor terminal 7. This consumer and investor terminal 7 has evaluation and investment system 7a. This evaluation and investment system 7a is made capable of grasping the circumstances of dealings by manufacturers related to the environment by inputting information obtained from manufacturers.

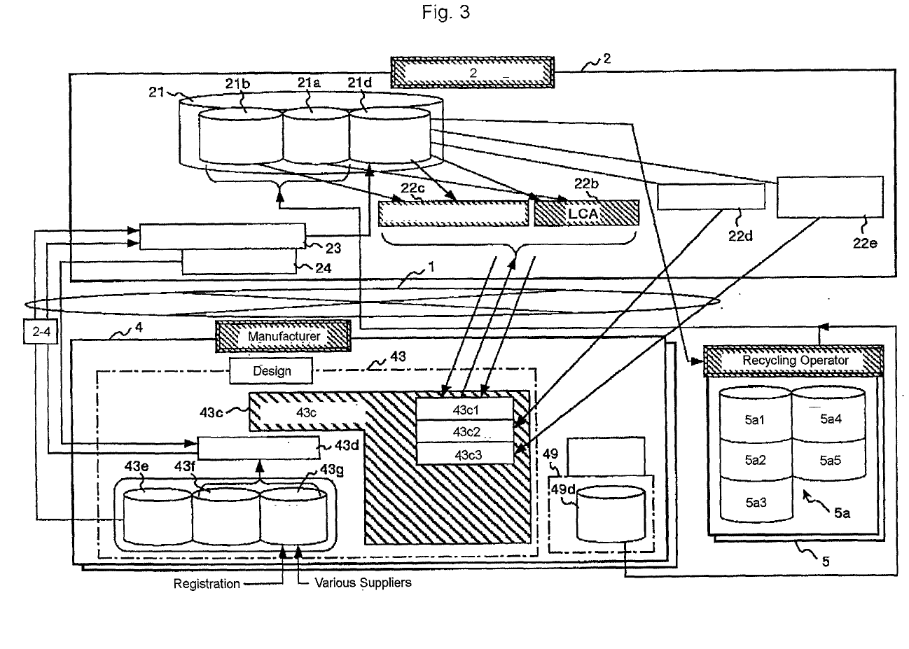

Next the method of support of enviromnentally concerned design of the present invention is explained, referring to FIG. 3. FIG. 3 is an explanatory drawing showing one preferred embodiment of the method of support of environmentally concerned design of the present invention.

This method of support of environmentally concerned design is performed in an environmentally concerned design system in which environmental operation information center server 2, manufacturer system 4, and recycling operator terminal 5 are connected via Internet 1. In this method of support of environmentally concerned design, it is possible to support efficient and assured performance of environmentally concerned design having considered environmental effect evaluation and recyclability in the design stage, utilizing products data and materials data possessed by manufacturer system 4. Below, this point is described concretely.

Manufacturer system 4 acquires a custom sheet from custom sheet providing system 24 of environmental operation information center server 2, creates a data file by inputting data into this custom sheet, and provides it by batch file transfer to automatic conversion system 23 of environmental operation information center server 2. By using a custom sheet in this manner, standardization of data is accomplished, and the present system can be utilized easily. Also, the data provided to this automatic conversion system 23 is a component list file created by design information creation system 43d based on data stored in components structure database 43f and materials and chemical substances database 43g, and the materials and hierarchical levels that cannot be released to the outside are filtered. Furthermore, manufacturer system 4 provides data of CAD database 43e to automatic conversion system 23 with filtering. Manufacturers that cannot perform filtering well provide raw data to automatic conversion system 23, and filtering is performed by automatic conversion system 23. By this, manufacturers can easily provide component list files and CAD data to the environmental operation information center.

And, environmental operation information center server 2 automatically converts these acquired component list files by automatic conversion system 23 and stores them in environmentally concerned design database 21d based on the confidentiality agreement. By this, they can be stored simply. These stored data are used as input data of environmentally oriented task support system 22a, LCA system 22b and decomposability/recyclability evaluation system 22c.

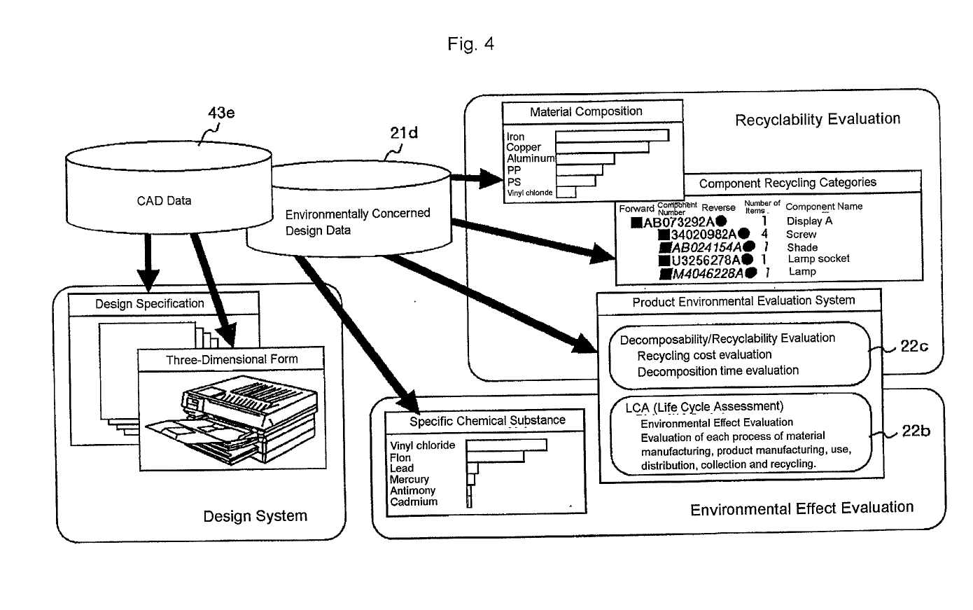

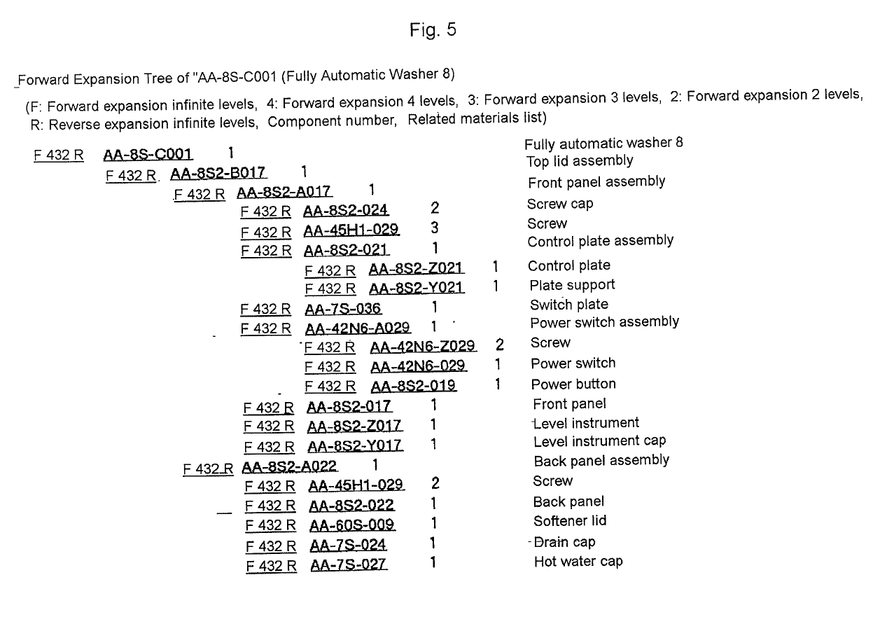

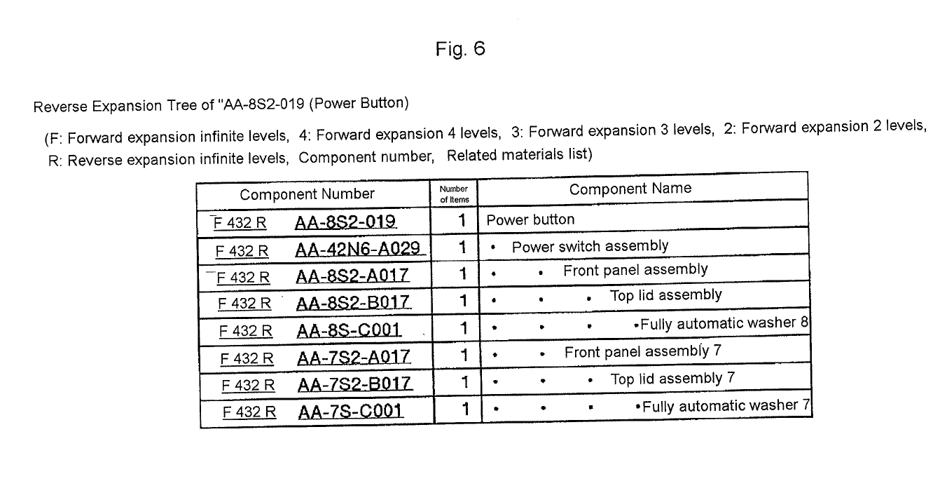

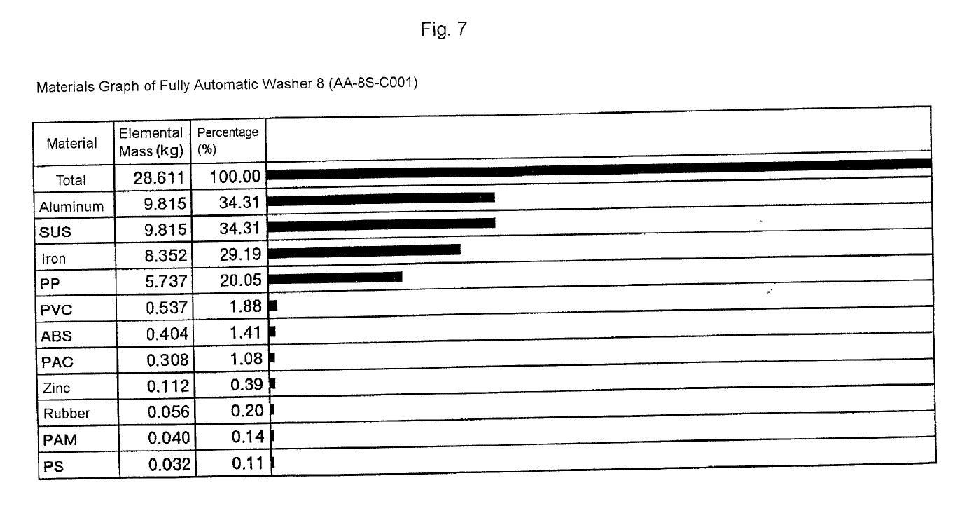

Here, concrete structures of data used in the method of support of environmentally concerned design are explained using FIG. 4 to FIG. 7. FIG. 4 is a drawing for explaining an example of outputting from the CAD database and the environmentally concerned design database in FIG. 3, FIG. 5 is a drawing showing an example of a screen output from the environmentally concerned design database in FIG. 3, FIG. 6 is a drawing showing another example of a screen output from the environmentally concerned design database in FIG. 3, and FIG. 7 is a drawing showing another example of a screen output from the environmentally concerned design database in FIG. 3. The data shown in these FIG. 4 through FIG. 7 is utilized also besides the method of support of environmentally concerned design shown in FIG. 3, in the overall environmental operation information system.

In FIG. 4, CAD database 43e can output design specifications and three-dimensional forms, and the like. And, when providing data of CAD database 43e to environmentally concerned design database 21d, it is desired to provide it by converting three-dimensionally curved surfaces so as to be approximate to planes, by automatic conversion system 23.

Also, regarding environmentally concerned design database 21d, components structure tables and chemical substances data, and the like, are provided being expressed in Excel sheets by design information creation system 43d, and they are used as data for outputting recycling categories to screen as lists, data for outputting material compositions and specific chemical substances to screen as bar graphs, data for performing evaluation of recycling cost and evaluation of decomposition time, and the like, in decomposability/recyclability evaluation system 22c, and data for performing environmental effect evaluation, and the like, in LCA system 22b.

As for examples of screens representing the recycling categories described above as lists, for example, there is the example of a screen representing with forward expansion shown in FIG. 5 and the example of a screen representing with reverse expansion shown in FIG. 6, and the like. An example of a screen representing with this list is divided into a plurality of hierarchical levels. By doing thus, forward expansion of an arbitrary hierarchical level, for example, for a component of which the number is extremely many can be displayed in short time, and in addition, products influenced by design modification and products including components that ceased to be manufactured can be retrieved at high speed. Also, an example of a screen representing with the bar graph described above, for example as in the screen example shown in FIG. 7, can represent a specified product, unit, and constituent materials and chemical substances for each component by elemental mass and percentage and bar graph thereof.

Returning to FIG. 3, environmental management department terminal 49 has fundamental units and weight coefficients database 49d, and provides fundamental units and weight coefficients data to environmental effect evaluation database 21a of environmental operation information center server 2. Environmental effect evaluation database 21a maintains standard fundamental units and weights data and is made such that these can be used in case that there is no provision of fundamental units and weight coefficients data from manufacturer system 4.

And, LCA system 22b performs environmental effect evaluation by inputting products data of environmentally concerned design database 21d, and fundamental units and weight coefficients data of environmental effect evaluation database 21a. Concretely, quantity of consumption or quantity of discharge A by each inventory item (iron ore, petroleum, CO₂, and the like) is computed by the computational equation A=Σ(a×W), and inventory analysis is performed. Here, W is the weight, processed quantity, and the like, by each material constituting the product, and a is the fundamental unit by each inventory item. Also, quantity of environmental load L by each category (warming; acid precipitation, and the like) is computed by the computational equation L=Σ(Δ×A), and impact evaluation is performed. Here, α is the weight coefficient by category.

Fundamental units are used separately for materials manufacturing, components processing, assembly, distribution and collection, use, crushing, sorting, recycling and burying, and the like. Also, weight coefficients are used separately for resource depletion, air pollution, warming, acid precipitation, destruction of ozone layer, and water pollution, and the like.

Environmentally concerned design system 43c acquires an input sheet from LCA system 22b, sends it back after inputting the data to be evaluated, and performs environmentally concerned design based on evaluation results received after that.

Thus, with the present method of support of environmentally concerned design, by devising sharing of information (component names/structures, mass, and the like), a great reduction of man-hours of input becomes possible, and examination of environmentally concerned design becomes easier. Moreover, because it is performed based on a confidentiality agreement, manufacturers can easily entrust environmental evaluation to the environmental operation information center which is an outsider, and the burden pertaining to environmental evaluation on manufacturers can be alleviated.

Furthermore, with the present method of support of environmentally concerned design, decomposition operations, materials, masses, and the like, are input, decomposability (decomposition time, decomposition expense, decomposability evaluation points) and recyclability (recycling expense, recycling capability ratio, recycling evaluation points) are quantitatively evaluated, and design of assembly products that are easy to decompose and are easy to recycle, having considered the environment, can be supported. Below, this point is described concretely.

Recycling operator terminal 5 has recycling process database 5a which consists of a decomposition work procedure database, unit price information database, treatment and disposal details database, treatment cost and disposal cost/capability database, and decomposition time database, and these data are provided to decomposability/recyclability evaluation database 21b of environmental operation information center server 2. Decomposability/recyclability evaluation database 21b maintains standard recycling process data and is made such that these can be used in case that there is no provision of recycling process data from manufacturer system 4.

And decomposability/recyclability evaluation system 22c performs decomposability/recyclability evaluation by inputting product data of environmentally concerned design database 21d and recycling process data of decomposability/recyclability evaluation database 21b. Environmentally concerned design system 43c acquires an input sheet from decomposability/recyclability evaluation system 22c, sends it back after inputting data to be evaluated, and performs environmentally concerned design based on evaluation results received after that.

Environmentally concerned design system 43c can retrieve material compositions of green materials constituting assembly products, totalization results, and places where green materials are used in component tables and drawings by web searching green procurement support system 22d of environmental operation information center server 2. By this, each design department can perform environmentally concerned design based on these retrieved green products information.

Environmentally concerned design system 43c can retrieve information of content chemical substances of components constituting assembly products by web searching product content chemical substance management system 22e of environmental operation information center server 2. By this, each design department can perform environmentally concerned design based on these retrieved information of content chemical substances.

Thus, with the present method of support of environmentally concerned design, decomposability/recyclability of products can be quantitatively evaluated from design information, and in addition, easy evaluation by designers can be realized by making recycling processes knowledge databases, and in addition, easy and efficient recycling by recycling operators is made possible.

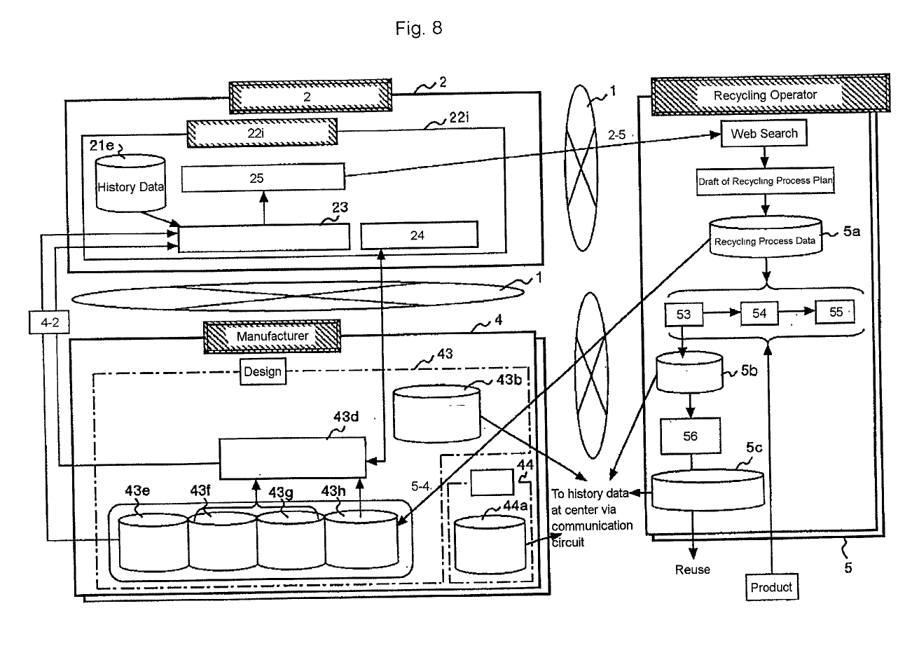

Next, the method of providing recycling support information of the present invention is explained, referring to FIG. 8. FIG. 8 is an explanatory drawing showing one preferred embodiment of the system for providing recycling support information of the present invention.

This method of providing recycling support information is performed in a system for providing recycling support information in which environmental operation information center server 2, manufacturer system 4, and recycling operator terminal 5 are connected via Internet 1. In this method of providing recycling support information, product design information is employed when creating information oriented toward recycling work (component structural drawings, component specifications, treatment process tables, treatment methods, and the like) in the design department, and creation of data to be provided can be supported. By this, the amount of man-hours of data creation can be greatly reduced. Also, by providing the above-mentioned information to recycling operators, the optimal recycling processes can be planned by the recycling operators, and suitability of recycling treatment can be realized. Below, this point is described concretely.

Manufacturer system 4 acquires a custom sheet from custom sheet providing system 24 of environmental operation information center server 2, creates a data file by inputting data to this custom sheet, and provides it by batch file transfer to automatic conversion system 23 of environmental operation information center server 2. By using a custom sheet in this manner, standardization of data is accomplished, and the present system can be utilized easily.

Also, the data provided to this automatic conversion system 23 is a component list file created by design information creation system 43d based on data stored in components structure database 43f, and materials and chemical substances database 43g, and recycling process order data created by design information creation system 43d based on data stored in recycling process database 43h. This component list file is provided with filtering of materials and levels, and the like. And, the data of recycling process database 43h is acquired from recycling process database 5a of recycling operator terminal 5 and is stored. Furthermore, manufacturer system 4 provides data of CAD database 43e to automatic conversion system 23 with filtering of curved surfaces, and the like. Manufacturers that cannot perform filtering well provide raw data to automatic conversion system 23, and filtering is performed by automatic conversion system 23. Thus, manufacturers can easily provide component list files and CAD data to the environmental operation information center.

Also, product and component life data is provided from product and component life database 43b via communication circuit 1 as input data of history database 21e of the environmental operation information center, and in addition, assembly records data is provided from assembly records database 44a via communication circuit 1 as input data of history database 21e of the environmental operation information center.

Furthermore, environmental operation information center server 2 automatically converts these acquired component list files and process order data by automatic conversion system 23 based on the confidentiality agreement, furthermore automatically web-converts them, and provides them to recycling operator terminal 5. Thus, because the provided data is created by utilizing product data for production, increased efficiency of creation of the provided data can be accomplished. Moreover, by two-stage conversion of production data, increased efficiency of compiling processing can be accomplished. Regarding automatic conversion by automatic conversion system 23, it is desirable that the monetary amount be first determined according to the quantity of the number of components.

And, the recycling operator drafts a recycling process plan by web searching recycling support product information providing system 22i using recycling operator terminal 5, and then registers that recycling process plan in recycling process database 5a. Furthermore, the recycling operator decomposes, treats, and disposes of assembly products based on this recycling process plan. These decomposed components are inspected after these decomposition records are registered in decomposition records database 5b, and they are repaired when necessary and reused. Inspection/repair records are registered in inspection/repair records database 5c. Data of decomposition records database 5b and inspection/repair records database 5c are provided as input data of history database 21e of the environmental operation information center via communication circuit 1.

Thus, the recycling operator knows the places to be decomposed and the places where decomposition is unnecessary before putting in a warehouse, and because a recycling process plan can be drafted based on this, making recycling treatment efficient and suitable can be accomplished. Also, overall structural drawings, product specifications, main components tables, component composition tables, treatment process tables, and the like, are made to be known by web-searching, and sorting can be performed easily based on this.

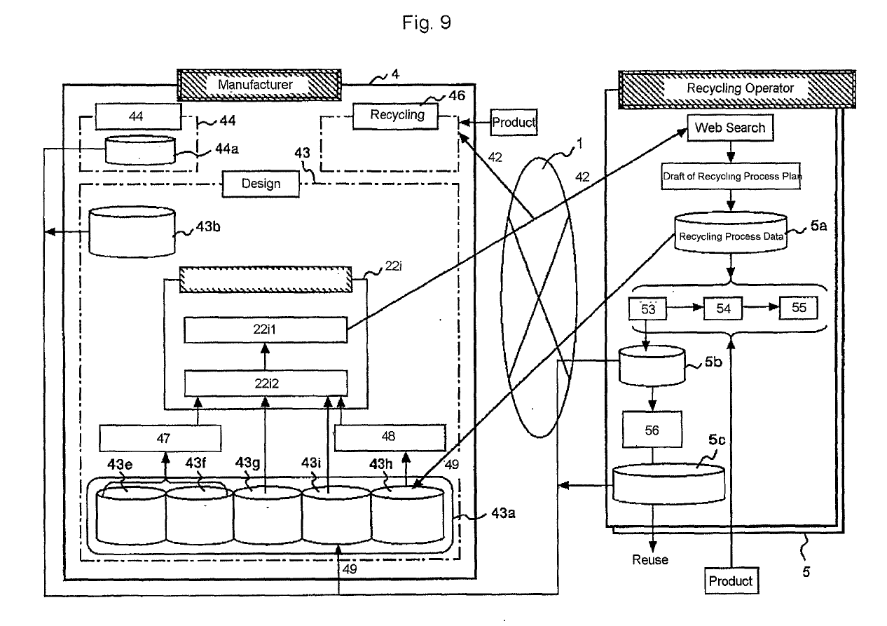

Next, a different system for providing recycling support information of the present invention is explained, referring to FIG. 9. FIG. 9 is an explanatory drawing showing another preferred embodiment of the system for providing recycling support information of the present invention. Below, the points that differ from the system for providing recycling support information explained with FIG. 8 are mainly explained.

The present system for providing recycling support information is constituted by manufacturer system 4 and recycling operator terminal 5 being connected via Internet 1. That is, instead of that data is provided from manufacturer system 4 to environmental operation information center server 2, and the data is converted at environmental operation information center server 2 and is provided to recycling operator terminal 5, rather the data is converted by the manufacturer system itself and is provided to recycling operator terminal 5.

The manufacturer possesses recycling support product information providing system 22i, and there is no need of filtering for data provided from design department database 43a to recycling support product information providing system 22i. When automatically converting with recycling support product information providing system 22i, data filtering is performed, and it is provided to the recycling operator. Also, design department database 43a has history database 43i. This history database 43i acquires respective data from assembly records database 44a, product and component life database 43b, as well as decomposition records database 5b and inspection/repair records database 5c of recycling operator terminal 5, and provides them to recycling support product information providing system 22i.

Also, when the manufacturer itself has a recycling department, data with the same contents as the contents provided to recycling operator terminal 5 is provided to that recycling department terminal 46.

According to the one embodiment of the present invention, it is possible to obtain a method of support of environmentally concerned design of manufactured goods in which a manufacturer can easily entrust environmental evaluation of manufactured goods to an external environmental evaluator, and the burden pertaining to environmental evaluation of manufactured goods of a manufacturer can be alleviated.

Also, according to the other embodiment of the present invention, it is possible to obtain a system for providing recycling support information and method of providing the same in which a recycling operator can easily perform product recycling having fully considered the environment.

Also, according to the other embodiment of the present invention, it is possible to obtain a method of support of environmental operation in which environmental evaluation can be entrusted by sending environmental data of each department of a manufacturer to an external evaluator, and tasks having considered the environment of manufactured goods can be performed across all departments of a manufacturer.

What is claimed is:

1. A method of support of environmentally concerned design of manufactured goods, wherein:
a confidentiality agreement is mutually concluded between an environmental evaluator that possesses an environmentally concerned design database and a plurality of assembly manufacturers;
the above manufacturers provide component list files constituted based on component structures related to their assembly products and materials and chemical substances thereof to the above environmental evaluator via a communication circuit; and
the above environmental evaluator performs a process of environmental evaluation of said products by computer based on the above environmentally concerned design database, and sends the evaluation results to the manufacturers of said assembly products via the communication circuit.

2. The method of support of environmentally concerned design of manufactured goods recited in claim 1, wherein:
the above manufacturers perform environmentally concerned design of the above assembly products by considering the above evaluation results.

3. The method of support of environmentally concerned design of manufactured goods recited in claim 1, wherein:
the above environmental evaluator acquires or possesses fundamental units and weight coefficients data related to said assembly products of said manufacturers, performs environmental effect evaluation of said assembly products based on that data, and provides results of that evaluation to the above manufacturers.

4. The method of support of environmentally concerned design of manufactured goods recited in claim 1, wherein:
the above manufacturers acquire or possess necessary information for recycling from a recycling operator.

5. The method of support of environmentally concerned design of manufactured goods recited in claim 4, wherein:
the above necessary information includes decomposition work procedure, treatment cost and disposal cost/capability, unit price, decomposition time, and treatment and disposal details.

6. The method of support of environmentally concerned design of manufactured goods recited in claim 1, wherein:
the above environmental evaluator possesses at least an environmental effect evaluation database, a decomposability/recyclability database and an environmentally concerned design database.

7. The method of support of environmentally concerned design of manufactured goods recited in claim 1, wherein:
the design department of the above manufacturer provides environmentally concerned design data to the environmental management department of said manufacturer.

8. The method of support of environmentally concerned design of manufactured goods recited in claim 1, wherein:
the above manufacturer acquires information related to materials and chemical substances from the suppliers of components and materials.

9. A system for providing recycling support information comprising:
a means for creating a component list file from components structure data related to assembly products, and materials and chemical substances data thereof possessed by manufacturers;
a means for converting this component list file into web compliant data; and
a means for sending the above web compliant data to a recycling operator via a communication circuit.

10. A system for providing recycling support information comprising:
a means for creating a component list file from components structure data, and materials and chemical substances data based on design data of assembly products of a manufacturer that manufactures said assembly products;
a means for converting this component list file into web compliant data; and
a means for sending the converted component list file to a recycling operator via a communication circuit.

11. The system for providing recycling support information recited in claim 9 or 10 comprising:
a means for acquiring recycling process data of the above recycling operator by the above manufacturer via a communication circuit.

12. A method of providing recycling support information, wherein:
a component list file is created from components structure data, and materials and chemical substances data based on design data related to assembly products possessed by a manufacturer;
the above component list file is provided to a provider that possesses a system for providing recycling support information;
the above provider converts the above component list file into web compliant data; and
the above provider provides the above web compliant data to a recycling operator.

13. The method of providing recycling support information recited in claim 12, wherein:
the above provider converts history data such as decomposition records and inspection/repair records together with the above component list file into web compliant data; and
the above provider provides the above web compliant data to the above recycling operator.

14. The method of providing recycling support information recited in claim 12, wherein:
the above manufacturer further provides CAD data and recycling process data.

15. The method of providing recycling support information recited in claim 12 or 13, wherein:
the above recycling operator provides recycling process data to the above manufacturer.

16. The method of providing recycling support information recited in claim 12, wherein:
the above provider concludes a confidentiality agreement in advance with a plurality of manufacturers, and prevents leaking of information among manufacturers.

17. A method of support of environmental operation, wherein:
a confidentiality agreement is concluded between an environmental evaluator that possesses an environmental evaluation database and evaluation know-how and a plurality of manufacturers;
environmental data of design departments, manufacturing departments and environmental management departments related to assembly products of each manufacturer is sent to the above environmental evaluator via a communication circuit;
the above environmental evaluator performs a process of environmental evaluation of said products by computer based on the above database; and
the above evaluation results are sent to the above manufacturers via a communication circuit.

18. The method of support of environmental operation recited in claim 17, wherein:
the above evaluation results are informed a recycling operator and/or waste treatment operator based on agreement of the above manufacturers.

19. The method of support of environmental operation recited in claim 17 or 18, wherein:
operation support is performed in corporate or joint corporate group units of the above manufacturers.
